(19) United States
(12) Patent Application Publication
(10) Pub. No.: US 2023/0125376 A1
(43) Pub. Date: Apr. 27, 2023

(54) Selection Method of dangerous Bluetooth Device based on connection with Bluetooth Device

(71) Applicant: NORMA Inc., Seoul (KR)

(72) Inventors: Hyunchul Jung, Seoul (KR); Chang Nyoung Song, Seoul (KR)

(21) Appl. No.: 17/511,670

(22) Filed: Oct. 27, 2021

(51) Int. Cl. H04W 48/16; H04W 4/80; H04W 12/122

(52) U.S. Cl. CPC H04W 48/16; H04W 4/80; H04W 12/122

(57) ABSTRACT

According to an embodiment, there is provided a method for selecting a dangerous Bluetooth device including: a detecting step of discovering, by a selecting apparatus, a Bluetooth device; a connecting step of connecting, by the selecting apparatus, to the detected Bluetooth device; and a predicting step of predicting, by the selecting apparatus, a dangerous Bluetooth device among the Bluetooth devices discovered at the detecting step, based on at least one result of a result of the detecting step and a result of the connecting step.

### TECHNICAL FIELD

The present disclosure relates to a method for selecting a dangerous Bluetooth device based on connection with a Bluetooth device.

### BACKGROUND ART

Bluetooth refers to technology standards for enabling portable devices including portable PCs or mobile phones to be wirelessly connected with one another within a short-range. For example, Bluetooth supports various digital devices to be able to exchange voices and data with one another by using a radio frequency of an industrial scientific medical (ISM) band of 245 MHz, without a physical cable. For example, a Bluetooth communication module may be embedded in a mobile communication terminal or a laptop computer to support wireless communication. Due to such convenience, Bluetooth may be employed most of digital devices such as a personal digital assistant (PDA), a desktop, a facsimile machine, a keyboard, or a joystick.

### DISCLOSURE

### Technical Problem

According to an embodiment of the present disclosure, there are provided a method for selecting a dangerous Bluetooth device and a selecting apparatus used therefor.

### Technical Solution

According to an embodiment, a method for selecting a dangerous Bluetooth device includes: a detecting step of discovering, by a selecting apparatus, a Bluetooth device; a connecting step of connecting, by the selecting apparatus, to the detected Bluetooth device: and a predicting step of predicting, by the selecting apparatus, a dangerous Bluetooth device among the Bluetooth devices discovered at the detecting step, based on at least one result of a result of the detecting step and a result of the connecting step.

The detecting step may include a first scanning step of scanning advertising packets broadcasted from Bluetooth devices, and a step of broadcasting a finishing packet for disconnecting Bluetooth devices which are already connected before the detecting step.

The connecting step may include performing, by the selecting apparatus, a connecting action of connecting to the Bluetooth device discovered at the detecting step, and performing, by the selecting apparatus, a device information acquiring action of acquiring service information from the connected Bluetooth device.

### Advantageous Effects

According to an embodiment of the present disclosure, a Bluetooth device having a malicious purpose such as hacking may be selected.

### DESCRIPTION OF DRAWINGS

FIGS. 1 to 3 are views to explain an apparatus for selecting a dangerous Bluetooth device based on connection with a Bluetooth device according to an embodiment of the present disclosure;

FIG. 4 is a view to explain a method for selecting a dangerous Bluetooth device based on connection with a Bluetooth device according to an embodiment of the present disclosure:

FIG. 5 is a view to explain a detecting step according to an embodiment of the present disclosure: and

FIG. 6 is a view to explain a detecting step according to another embodiment of the present disclosure.

### MODE FOR INVENTION

Preferred embodiments will now be described more fully with reference to the accompanying drawings to clarify aspects, other aspects, features and advantages of the present disclosure. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art.

### Definition of Terms

In the detailed descriptions, a term ‘software’ refers to technology for moving hardware in a computer, the term ‘hardware’ refers to a tangible device or apparatus (a central processing unit (CPU), a memory, an input device, an output device, a peripheral device, etc.) constituting a computer. A term ‘step’ refers to a series of processes or operations connected in time series to achieve a predetermined object. A term ‘program’ refers to a set of instructions suitable for processing by a computer, and a term ‘program recording medium’ refers to a computer-readable recording medium having a program installed therein, and having a program recorded thereon to execute or distribute.

In the detailed descriptions, when terms such as first, second are used to describe various elements, the elements should not be limited by such terms. These terms are used for the purpose of distinguishing one element from another element only. The exemplary embodiments explained and exemplified herein include their complementary embodiments.

As used herein, the singular forms “a”, “an” and “the” are intended to include the plural forms as well, unless the context clearly indicates otherwise. It will be further understood that the terms “comprises” and/or “comprising,” when used in the detailed descriptions, do not preclude the presence or addition of one or more other components.

In the detailed descriptions, the term ‘management’ has a meaning including ‘receiving,’ ‘transmitting,’ “storing,’ ‘modifying,’ or ‘deleting’ data.

In the detailed descriptions, ‘component A and/or component B’ refers to ‘component A,’ ‘component B’ or ‘component A and component B.’

In the detailed descriptions, a ‘user terminal device’ may be a computer, and for example, may be a device like a desktop computer, a notebook computer, a smartphone, or a PDA.

In the detailed descriptions, a ‘computer’ may include a computer processor and a storage device, an operating system, firmware, an application program, a communication unit, and other resources. Herein, the operating system (OS) may operatively connect other hardware, firmware or application programs (for example, a management program). The communication unit refers to a module consisting of software and hardware for exchanging data with an outside. In addition, the computer processor, the storage device, the operating system, the application program, the firmware, the communication units, and other resources may be operatively connected with one another. The above-mentioned components are described and illustrated only for the purpose of explaining the present disclosure.

In the detailed descriptions, a component ‘A’ transmitting information, history, and/or data to a component ‘B’ means that the component ‘A’ directly transmits to the component ‘B’ or the component ‘A’ transmits to the component ‘B’ via at least one other component.

In the detailed descriptions, the term ‘Bluetooth device’ refers to a device that communicates by using wireless communication technology, Bluetooth.

Hereinafter, embodiments of the present disclosure will be described in detail with reference to the accompanying drawings.

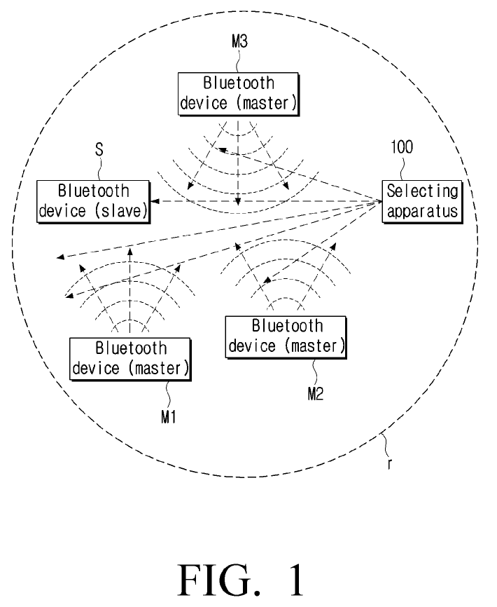

FIGS. 1 to 3 are views to explain an apparatus for selecting a dangerous Bluetooth device, based on connection with Bluetooth devices according to an embodiment of the present disclosure.

Referring to FIGS. 1 to 3, the apparatus 100 for selecting the dangerous Bluetooth device based on connection with the Bluetooth devices (hereinafter, referred to as a ‘selecting apparatus’) according to an embodiment of the present disclosure performs a detecting action, a connecting action, a device information acquiring action, and a dangerous device predicting action.

For the sake of explanation of the present disclosure, it is assumed that there are four Bluetooth devices S, M1, M2, M3, and with respect to one Bluetooth device S, the other Bluetooth devices M1, M2, M3 are masters. That is, the Bluetooth device S is a slave and the Bluetooth devices M1, M2, M3 are masters. The slave and the master are relative devices. For example, when the Bluetooth device M1 and the Bluetooth device M2 try to connect to each other, one of these devices is a slave and the other one is a master. According to an embodiment, the selecting apparatus 100 of the present disclosure may serve as a slave or a master with respect to the Bluetooth devices S, M1, M2, and M3.

In order to connect to the slave S, the masters M1, M2, M3 periodically scan an advertising packet (hereinafter, referred to as an ‘AD packet’) which is broadcasted from the slave S. When the slave S broadcasts the AD packet, the masters M1, M2, M3 may request connection to the slave S. When the master M1 connects to the slave S, the master M1 may set a timing and may perform a data exchange operation with the slave S.

The slave S periodically broadcasts an AD packet to connect with another Bluetooth device. When the master M1 receives the AD packet and transmits a connection request to the slave S, the slave S accepts the connection request and connects. For example, when the master M1 and the slave S connect to each other, the slave S exchanges data with the master M1 while hopping a channel according to a timing designated by the master M1.

The AD packet may include, for example, a media access control address (hereinafter, referred to as a ‘MAC address’), a universally unique identifier (UUID), a vendor unique number, and data indicating a type of a Bluetooth device.

Herein, the MAC address is a unique identifier that is allocated to a network interface for communication on a data link layer of a network segment. The MAC address is used as a network address in most of IEE 802 network standards including ethernet and WiFi.

The UUID is a unique number for identifying a software service. According to Bluetooth standards, services provided by a Bluetooth device have unique UUID values to be distinguished from one another, and a service defined in Bluetooth standards may have an already defined 16-bit UUID value. On the other hand, a service directly defined by a user may have a 128-bit UUID.

The vendor unique number is information indicating a manufacturer of a Bluetooth device.

### Detecting Action

The detecting action refers to an action of discovering, by the selecting apparatus 100, the Bluetooth devices S, M1, M2, M3.

In the present embodiment, the detecting action is an action of detecting all Bluetooth devices S, M1, M2, M3 existing in a region for detecting (hereinafter, a ‘detecting region’). A target to detect includes Bluetooth devices that are already connected (that is, paired), and Bluetooth devices that are not yet connected, but try to connect.

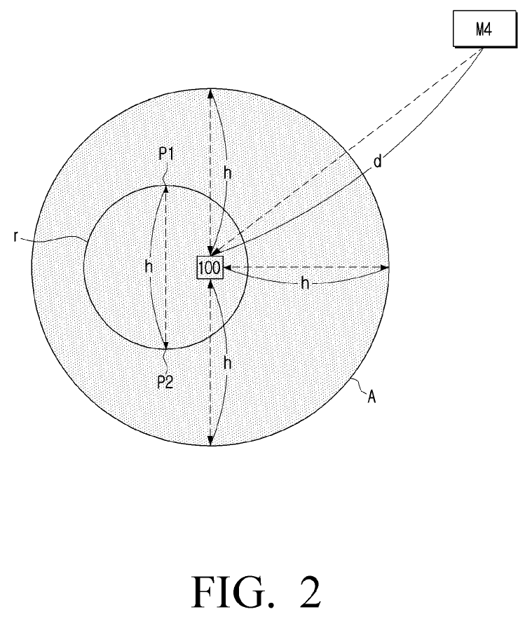

In the present embodiment, the detecting region is typically defined as being within a few meters or tens of meters, and is defined as a region where Bluetooth devices to be detected are located. For example, when a dangerous Bluetooth device is to be detected from Bluetooth devices located within a specific office, the detecting region may be defined as an inner space of the specific office. Referring to FIG. 2, the detection region (r) is displayed and the Bluetooth devices S, M1, M2, M3 are located within the detecting region (r). As will be described below, a Bluetooth device M4 is not located within the detecting region (r).

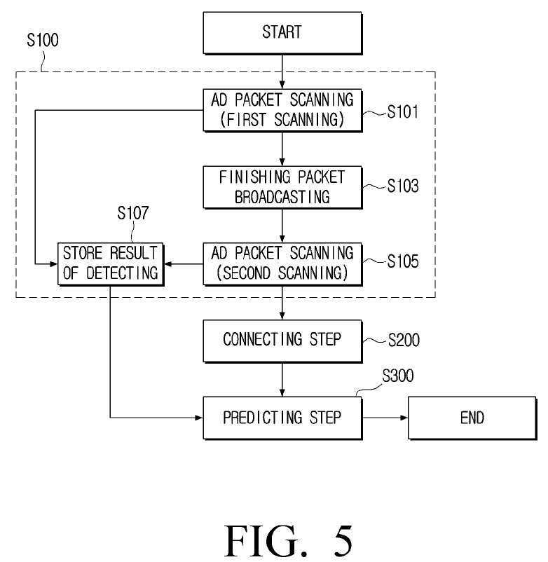

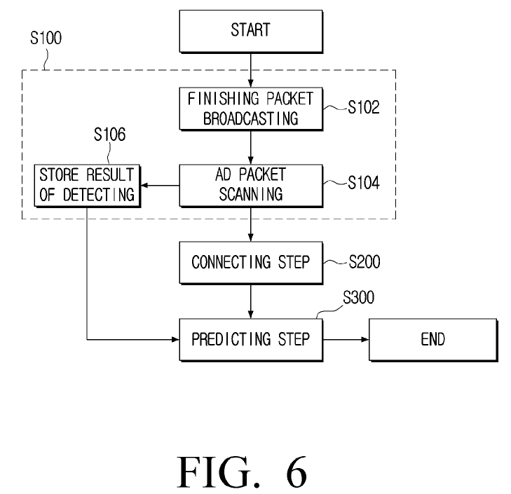

The detecting action may include, for example, an action of scanning AD packets broadcasted from the Bluetooth devices, and an action of storing the AD packets received as a result of scanning. The detecting action may be performed by a method (first embodiment) described with reference to FIG. 5, or may be performed by a method (second embodiment) described with reference to FIG. 6.

The detecting action according to the first embodiment may include an action of scanning, by the selecting apparatus 100, an AD packet in the detecting region (hereinafter, referred to as ‘first scanning’), an action of broadcasting a finishing packet to the detecting region, and an action of scanning an AD packet (hereinafter, referred to as ‘second scanning’).

The detecting action according to the first embodiment is an action of scanning an AD packet, first, and disconnecting Bluetooth devices which were already connected before the detecting action is performed, by broadcasting a finishing packet, and then, scanning an AD packet second. Since the Bluetooth devices which were already connected before the detecting action is performed would not be detected by the action of scanning the AD packet, it would be necessary to broadcast the finishing packet to disconnect the already-connected Bluetooth devices.

When the already connected Bluetooth devices receive the finishing packet, they are disconnected from one another. The disconnected Bluetooth devices broadcast AD packets to connect again, and the broadcasted AD packets are detected by the second scanning action.

The detecting action according to the second embodiment includes an action of broadcasting, by the selecting apparatus 100, a finishing packet to the detecting region, and an action of scanning an AD packet. That is, according to the second embodiment, the detecting action is an action of broadcasting a finishing packet to the detecting region to disconnect the already connected Bluetooth devices, and then scanning an AD packet. As described above, the disconnected Bluetooth devices broadcast AD packets to connect again, and the broadcasted AD packets are detected by the scanning action.

### Connecting Action

The connecting action is an action of connecting, by the selecting apparatus 100, to the Bluetooth devices discovered by the detecting action in sequence.

The connecting action includes actions of connecting, by the selecting apparatus 100, to all Bluetooth devices detected at the detecting action in sequence, and acquiring device information from the connected Bluetooth devices (hereinafter, referred to as a device information acquiring action′). For example, the selecting apparatus 100 may connect to the Bluetooth devices S, M1, M2, M3 in sequence, and may acquire device information from the connected Bluetooth devices S, M1, M2, and M3.

The above-described device information acquiring action is an action of acquiring, by the selecting apparatus 100, service information of the connected Bluetooth devices. For example, when the selecting apparatus 100 connects to the Bluetooth device M2, the selecting apparatus 100 may acquire service information from the Bluetooth device M2. According to an embodiment, the service information may include data indicating which service the Bluetooth device M2 may provide, and data indicating a type of the Bluetooth device M2. In the present embodiment, the service information may further include data indicating a current location of the Bluetooth device M2. Alternatively, the data indicating the current location of the Bluetooth device may be included in the AD packet.

### Dangerous Device Predicting Action

The dangerous device predicting action is an action of predicting a dangerous Bluetooth device among the Bluetooth devices S, M1, M2, M3, based on at least one result of the result of the detecting action and the result of the connecting action. That is, the dangerous device predicting action is an action of i) predicting a dangerous Bluetooth device based on the result of the detecting action, ii) predicting a dangerous Bluetooth device based on the result of the connecting action, or iii) predicting a dangerous Bluetooth device based on the result of the detecting action and the result of the connecting action.

An embodiment of predicting the dangerous Bluetooth device based on the result of the detecting action will be described hereinbelow.

According to the present embodiment, the selecting apparatus 100 extracts MAC addresses of the Bluetooth devices from the AD packets detected by the detecting action, finds the Bluetooth devices having the same MAC address among the extracted MAC addresses, and predicts the Bluetooth devices having the same MAC address as dangerous Bluetooth devices. For example, when a MAC address extracted from the AD packet broadcasted from the Bluetooth device M1, and a MAC address extracted from the AD packet broadcasted from the Bluetooth device M2 are the same as each other, the selecting apparatus 100 predicts the Bluetooth device M1 and the Bluetooth device M2 as dangerous Bluetooth devices.

Another embodiment of predicting a dangerous Bluetooth device based on the result of the detecting action will be described hereinbelow.

According to the present embodiment, the selecting apparatus 100 extracts MAC addresses from the AD packets detected by the detecting action, and identifies whether there exists a MAC address having an untypical format among the extracted MAC addresses. The selecting apparatus 100 predicts a Bluetooth device having the MAC address of the untypical format as a dangerous Bluetooth device.

In the detailed descriptions, the MAC address of the untypical format refers to a MAC address that is configured in a different format from typical MAC addresses allocated to the Bluetooth devices.

A typical MAC address has a unique number for each vendor (hereinafter, referred to as a ‘vendor unique number’), and may be used as information indicating a manufacturer of a corresponding device through the MAC address.

The MAC address of the untypical format may include a vendor unique number of a company that does not manufacture Bluetooth devices for business.

An embodiment of predicting a dangerous Bluetooth device based on the result of the detecting action and the result of the connecting action will be described hereinbelow.

According to the present embodiment, when a strength of a signal of the AD packet detected by the detecting action is stronger than a ‘reference value’ and a location of the Bluetooth device transmitting the AD packet is out of a ‘reference range’, the selecting apparatus 100 may predict the Bluetooth device as a dangerous device. Herein, the reference range’ refers to a range from the selecting apparatus 100 within a reference distance (h) (for example, a portion shaded in FIG. 2 indicates a ‘reference range’).

For example, on the assumption that the Bluetooth devices S, M1, M2. M3 are located in the detecting region (r), the ‘reference value’ may be defined with reference to strengths of signals of AD packets. For example, the ‘reference value’ may be a smallest value of the strengths of the signals of the AD packets.

The ‘reference distance’ (h) may be defined based on the size of the detecting region (r). For example, the reference distance (h) may be defined by a distance between two Bluetooth devices when the two Bluetooth devices are virtually arranged farthest from each other within the detecting region (r). Referring to FIG. 2, a distance between positions P1, P2 of the two Bluetooth devices that are farthest from each other within the detecting region (r) may be defined as the reference distance (h).

The reference range′ (A) may be defined as a region from the selecting apparatus 100 within the reference distance (h). Referring to FIG. 2, the ‘reference range’ (A) is displayed as a region from the selecting apparatus 100 within the reference distance (h).

Referring to FIG. 2, a position of the Bluetooth device M4 is out of the ‘reference range’. When a strength of a signal of an AD packet from the Bluetooth device M4 is stronger than the reference value, the selecting apparatus 100 may predict the Bluetooth device M4 as a dangerous device since the location of the Bluetooth device M4 is out of the ‘reference range’.

Location data (for example, GPS coordinates) indicating a location of a Bluetooth device may be included in service information provided when the Bluetooth device is connected, or an AD packet transmitted from the Bluetooth device. The selecting apparatus 100 may identify a distance between the Bluetooth device and the selecting apparatus 100 by using the location information included in the service information or the AD packet provided from the Bluetooth device.

Another example of predicting a dangerous Bluetooth device based on the result of the detecting action and the result of the connecting action will be described hereinbelow.

The selecting apparatus 100 may compare a type of a service identified from an AD packet, and a type of a service identified from service information provided by connection to a Bluetooth device, and, when the types of the services are different, may predict the Bluetooth device as a dangerous device. For example, when a type of a service identified from a UUID included in the AD packet received from the Bluetooth device M3, and a type of a service identified from service information provided by the Bluetooth device M3 when the selecting apparatus 100 connects to the Bluetooth device M3 are different from each other, the selecting apparatus 100 may predict the Bluetooth device M3 as a dangerous device.

Still another example of predicting a dangerous Bluetooth device based on the result of the detecting action and the result of the connecting action will be described hereinbelow.

When a type of a Bluetooth device identified from an AD packet and a type of a Bluetooth device identified from service information acquired by the device information acquiring action are not the same as each other, the selecting apparatus 100 predicts the Bluetooth device as a dangerous Bluetooth device. For example, when the type of the Bluetooth device M3 identified from data included in the AD packet received by the selecting apparatus 100 from the Bluetooth device M3, and the type of the Bluetooth device M3 identified from the service information provided from the Bluetooth device M3 when the selecting apparatus 100 connects to the Bluetooth device M3 are different from each other, the selecting apparatus 100 predicts the Bluetooth device M3 as a dangerous device.

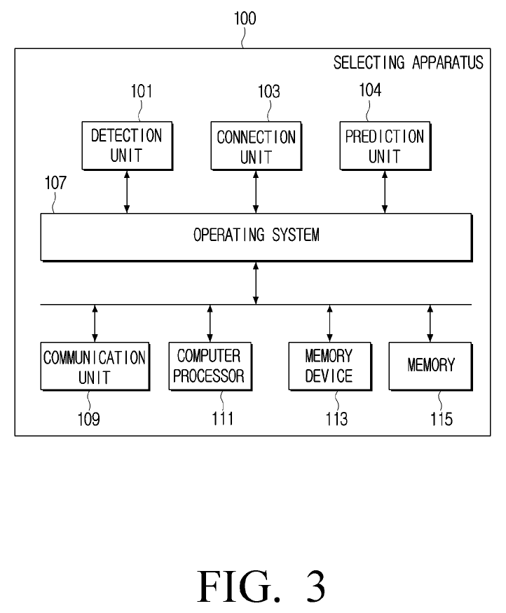

Referring to FIG. 3,the apparatus 100 for selecting the Bluetooth device may include a detection unit 101, a connection unit 103. a prediction unit 105, an operating system 107, a communication unit 109, a computer processor 111, a memory device 113, and a memory 115.

Herein, the operating system 107 refers to software that provides a hardware abstraction platform and a common system service not only to manage hardware but also to execute application software, and the memory device 113 and the memory 115 are devices that provide a space to store and execute respective programs. The computer processor 111 may be a central processing unit (CPU), and such a central processing unit is a control device of a computer for controlling a computer system and executing computation of a program, or a chip having such a function embedded therein.

The memory 115 and/or the memory device 113 provides a space to store or execute a program, and may store a reference value, a reference distance, AD packets, or service information provided from Bluetooth devices.

The detection unit 101 performs the above-described detecting action. For example, the detection unit 101 performs the action of detecting all Bluetooth devices S, M1, M2. M3 existing in the detecting region. A target to detect includes currently connected (that is, paired) Bluetooth devices, and Bluetooth devices which are not yet connected but try to connect.

The connection unit 103 performs the above-described connecting action and device information acquiring action. For example, the connection unit 130 performs the action of connecting to all Bluetooth devices detected by the detection unit 101 in sequence. In addition, when the Bluetooth device is connected, the connection unit 103 performs the device information acquiring action of acquiring service information of the connected Bluetooth device. For example, when the Bluetooth device M2 is connected, the connection unit 103 acquires service information from the Bluetooth device M2.

The prediction unit 105 performs the above-described dangerous device predicting action. For example, the prediction unit 105 performs the action of predicting a dangerous Bluetooth device among the Bluetooth devices S, M1, M2, and M3, based on at least one result of the result of the action by the detection unit 101 and the result of the action by the connection unit 103. That is, the prediction unit 105 i) predicts a dangerous Bluetooth device based on the result of the action by the detection unit 101. ii) predicts a dangerous Bluetooth device based on the result of the action by the connection unit 103, or iii) predicts a dangerous Bluetooth device based on the result of the action by the detection unit 101 and the result of the action by the connection unit 103.

An entirety or a part of the detection unit 101 may be configured by a program. The part configured by the program is loaded into the memory 150 to perform any action under control of the computer processor 111. At least part of the other components, for example, the connection unit 103 and the prediction unit 105 may be configured by a program like the detection unit 101 to perform its own action. The detecting action, the connecting action, and the dangerous device predicting action have been described above, and thus will not be described.

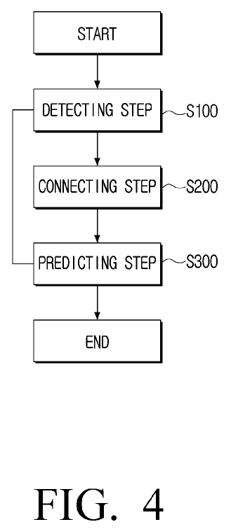

FIG. 4 is a view provided to explain a method of a selecting apparatus for selecting a dangerous Bluetooth device based on connection with a Bluetooth device (hereinafter, referred to as a ‘selecting method’) according to an embodiment of the present disclosure.

Hereinafter, the selecting method according to an embodiment of the present disclosure will be described in detail on the assumption that the selecting apparatus 100 described with reference to FIGS. 1 to 3 is used in the selecting method according to an embodiment of the present disclosure.

The selecting method according to an embodiment of the present disclosure may include: a first step of discovering, by the selecting apparatus 100, a Bluetooth device (hereinafter, referred to as a ‘detecting step’) (S100); a second step of connecting, by the selecting apparatus 100, to the Bluetooth device discovered at the detecting step (S100) (hereinafter, referred to as a ‘connecting step’) (S200); and a third step of predicting, by the selecting apparatus 100, a dangerous Bluetooth device among the Bluetooth devices discovered at the detecting step (S100), based on at least one result of the result of the detecting step (S100) and the result of the connecting step (S200) (hereinafter, referred to as a ‘dangerous device predicting step’) (S300).

### Detecting Step (S100)

The detecting step (S100) according to the present embodiment refers to an action of discovering Bluetooth devices S, M1, M2, M3.

The detecting step (S100) includes an action of detecting all Bluetooth devices S, M1, M2, M3 existing in a detecting region (r). A target to detect includes currently connected (that is, pair) Bluetooth devices, and Bluetooth devices that are not yet connected, but try to connect.

The detecting step (S100) may include, for example, a step of scanning AD packets broadcasted from the Bluetooth devices (S101), and a step of storing the AD packets received as a result of scanning (S107). The detecting step (S100) may be performed by the method (first embodiment) described with reference to FIG. 5, or may be performed by the method (second embodiment) described with reference to FIG. 6.

The first embodiment will be described with reference to FIG. 5. The detecting step (S100) may include a step of scanning, by the selecting apparatus 100, an AD packet in the detecting region (hereinafter, referred to as ‘first scanning’) (S101), a step of broadcasting a finishing packet to the detecting region (S103), and a step of scanning an AD packet (hereinafter, referred to as ‘second scanning’) (S105). That is, according to the first embodiment, the detecting step (S100) is an action of scanning an AD packet, first, and disconnecting Bluetooth devices which are already connected by broadcasting a finishing packet, and then, scanning an AD packet second. Since the Bluetooth devices which are already connected before the detecting step (S100) is performed are not detected by the action of scanning the AD packet, the existing Bluetooth devices are disconnected by broadcasting the finishing packet.

When the connected Bluetooth devices receive the finishing packet, they are disconnected from one another. The disconnected Bluetooth devices broadcast AD packets to connect again, and the broadcasted AD packets are detected by the second scanning action.

The second embodiment will be described with reference to FIG. 6. The detecting step (S100) includes a step of broadcasting, by the selecting apparatus 100, a finishing packet to the detecting region (S102), and a step of scanning an AD packet (S104). That is, according to the second embodiment, the detecting step (S100) is an action of broadcasting a finishing packet to the detecting region to disconnect already connected Bluetooth devices, and then scanning an AD packet. Since the Bluetooth devices already connected before the detecting step (S100) is performed are not detected by the action of canning the AD packet, the existing Bluetooth devices are disconnected by broadcasting the finishing packet.

As described above, the disconnected Bluetooth devices broadcast AD packets to connect again, and the broadcasted AD packets are detected by the scanning action.

### Connecting Step (S200)

At the connecting step (S200), the connection unit 103 performs the connecting action and the device information acquiring action described above. For example, the connecting step (S200) includes an action of connecting to all Bluetooth devices detected by the detecting step (S100) in sequence. In addition, the connecting step (S200) includes, when the Bluetooth device is connected, performing the device information acquiring action of acquiring service information of the connected Bluetooth device. For example, the connecting step (S200) includes acquiring service information from the Bluetooth device M2 when the Bluetooth device M2 is connected.

### Predicting Step (S300)

The predicting step (S300) includes performing the above-described dangerous device predicting action.

For example, the predicting step (S300) is an action of predicting a dangerous Bluetooth device among the Bluetooth devices S, M1, M2, M3, based on at least one result of the result of the action by the detecting step (S100) and the result of the action by the connecting step (S200). That is, the predicting step (S300) includes predicting a dangerous Bluetooth device based on the result of the action by the detecting step (S100), predicting a dangerous Bluetooth device based on the result of the action by the connecting step (S200), or predicting a dangerous Bluetooth device based on the result of the action by the detecting step (S100) and the result of the action by the connecting step (S200).

According to an embodiment, the predicting step (S300) may include extracting MAC addresses from the AD packets found at the detecting step (S100), and predicting Bluetooth devices that have the same MAC address among the MAC addresses extracted at the step of extracting the MAC addresses, as dangerous Bluetooth devices.

According to an embodiment, the predicting step (S300) may include extracting MAC addresses from the AD packets found at the detecting step (S100), and predicting a Bluetooth device having a MAC address of an untypical format among the extracted MAC addresses as a dangerous Bluetooth device.

According to an embodiment, the predicting step (S300) may include, when a strength of a signal of an AD packet broadcasted from a Bluetooth device is stronger than a reference value and a location of the Bluetooth device transmitting the AD packet having the strength of the signal stronger than the reference value is out of a reference range, predicting the Bluetooth device transmitting the AD packet having the strength of the signal stronger than the reference value as a dangerous Bluetooth device.

According to an embodiment, the predicting step (S300) may include, when a type of a service identified from an AD packet received from a Bluetooth device discovered at the detecting step (S100), and a type of a service identified from the service information are not the same as each other, predicting the Bluetooth device as a dangerous Bluetooth device.

According to an embodiment, the predicting step (S300) may include, when a type of a Bluetooth device identified from an AD packet received from a Bluetooth device discovered at the detecting step (S100), and a type of a Bluetooth device identified from the service information are not the same as each other, predicting the Bluetooth device as a dangerous Bluetooth device.

The detecting action, the connecting action, and the dangerous device predicting action mentioned in the above-described steps have been described in details above, and a detailed description thereof is omitted.

All or a part of the steps of the method for selecting the dangerous Bluetooth device described above may be executed by a computer program. The computer program may be loaded into a memory and may be executed by a computer processor, and may be stored in a computer-readable storage medium (for example, a memory device).

While the present disclosure has been shown and described with reference to certain preferred embodiments thereof, it will be understood by those skilled in the art that various changes in form and details may be made therein without departing from the spirit and scope of the present disclosure as defined by the appended claims. Therefore, the scope of the present disclosure is defined not by the detailed descriptions of the present disclosure but by the appended claims, and all differences within the scope will be construed as being included in the present disclosure.

### Explanation of Signs

100: selecting apparatus
SM, M1, M2, M3, M4: Bluetooth device
101: detection unit
103: connection unit
105: prediction unit
107: operating system
109: communication unit
111: computer processor
113: memory device
115: memory

What is claimed is:

1. A method for selecting a dangerous Bluetooth device, the method comprising:
a detecting step of discovering, by a selecting apparatus, a Bluetooth device;
a connecting step of connecting, by the selecting apparatus, to the detected Bluetooth device: and
a predicting step of predicting, by the selecting apparatus, a dangerous Bluetooth device among the Bluetooth devices discovered at the detecting step, based on at least one result of a result of the detecting step and a result of the connecting step,
wherein the detecting step comprises a first scanning step of scanning advertising packets broadcasted from Bluetooth devices, and a step of broadcasting a finishing packet for disconnecting Bluetooth devices which are already connected before the detecting step,
wherein the connecting step comprises performing, by the selecting apparatus, a connecting action of connecting to the Bluetooth device discovered at the detecting step, and performing, by the selecting apparatus, a device information acquiring action of acquiring service information from the connected Bluetooth device.

2. The method of claim 1, wherein the predicting step comprises extracting MAC addresses from the advertising packets detected at the detecting step, and predicting Bluetooth devices having the same MAC address among the MAC addresses extracted at the step of extracting the MAC addresses as dangerous Bluetooth devices.

3. The method of claim 1, wherein the predicting step comprises extracting MAC addresses from the advertising packets detected at the detecting step, and predicting a Bluetooth device having a MAC address of an untypical format among the extracted MAC addresses as a dangerous Bluetooth device.

4. The method of claim 1, wherein the predicting step comprises, when a strength of a signal of an advertising packet broadcasted from a Bluetooth device is stronger than a reference value, and a location of the Bluetooth device transmitting the advertising packet having the strength of the signal stronger than the reference value is out of a reference range, predicting the Bluetooth device transmitting the advertising packet having the strength of the signal stronger than the reference value as a dangerous Bluetooth device.

5. The method of claim 1, wherein the predicting step comprises, when a type of a service identified from an advertising packet received from a Bluetooth device discovered at the detecting step, and a type of a service identified from the service information acquired at the device information acquiring step are not the same as each other, predicting the Bluetooth device as a dangerous Bluetooth device.

6. The method of claim 1, wherein the predicting step comprises, when a type of a Bluetooth device identified from an advertising packet received from a Bluetooth device discovered at the detecting step, and a type of a Bluetooth device identified from the service information acquired at the device information acquiring step are not the same as each other, predicting the Bluetooth device as a dangerous Bluetooth device.

7. The method of claim 1, wherein the step of broadcasting the finishing packet precedes the first scanning step.

8. The method of claim 1, wherein the detecting step further comprises a second scanning step of scanning advertising packets broadcasted from Bluetooth devices, and
wherein the first scanning step, the step of broadcasting the finishing packet, and the second scanning step are performed in sequence.
